(19) United States
(12) Patent Application Publication
(10) Pub. No.: US 2026/0316195 A1
(43) Pub. Date: Oct. 15, 2026

(54) WEAVING CONTROL METHOD, WELDING CONTROL DEVICE, WELDING SYSTEM, PROGRAM, AND WELDING METHOD

(71) Applicant: Kabushiki Kaisha Kobe Seiko Sho (Kobe Steel, Ltd.), Kobe-shi (JP)

(72) Inventors: Junichi KAWATA, Fujisawa-shi (JP); Takeshi YANO, Fujisawa-shi (JP); Keita OZAKI, Tokyo (JP)

(73) Assignee: Kabushiki Kaisha Kobe Seiko Sho (Kobe Steel, Ltd.), Kobe-shi (JP)

(21) Appl. No.: 19/117,118

(22) PCT Filed: Dec. 1, 2023
(86) PCT No.: PCT/JP2023/043159

§ 371 Date: Mar. 31, 2025

(30) Foreign Application Priority Data
Jan. 23, 2023 (JP) 2023-008145

(51) Int. Cl. B23K 37/02; G05B 19/402

(52) U.S. Cl. CPC B23K 37/0252; G05B 19/402; G05B 2219/45135

(57) ABSTRACT

A weaving control system acquires, from command information, first weaving information including torch position during weaving, and acquires, from information about an image obtained by imaging the surroundings of the tip of the torch during welding, second weaving information including welding center position and the torch position during weaving in a weaving width direction perpendicular to a welding line; sets a first stop period and a second stop period which include the timings at which the torch stops at one side weaving end and the other side weaving end, and calculates, on the basis of the second weaving information, each representative value of relative deviations between the welding center position and the torch position in the first stop period and the second stop period; and calculates correction amounts for copying the welding line according to the deviations within the periods obtained on the basis of these representative values.

### TECHNICAL FIELD

The present invention relates to weaving control methods, welding control devices, welding systems, programs, and welding methods.

### BACKGROUND ART

Weld-line tracking control is one of various types of control (also referred to as “weaving control” hereinafter) related to oscillation (referred to as “weaving” or “welding torch movement” hereinafter) of a welding torch. In the related art, weld-line tracking control is normally a technique (also referred to as “arc sensor” hereinafter) involving comparing electric currents at both ends during weaving and tracking the weld line. This arc sensor has disadvantages in that, for example, it leads to lower accuracy when a special current waveform is used, it is difficult to be applied to non-consumable-type arc welding, such as TIG welding or plasma welding, and it is vulnerable to situational changes, such as tack welding, and disturbances. In contrast, a weld-line tracking control method employing image processing is used in recent years.

For example, Patent Literature 1 discloses a tracking control method that does not use an expensive laser sensor in non-consumable-type arc welding, such as TIG welding or plasma welding, where it is difficult for the arc sensor to detect displacement in the left-right direction of the groove position. In this control, an image processing device derives a shift amount of the groove position relative to the welding torch based on positional coordinates of a welding-electrode reflection image obtained from a captured image, and a robot control device performs tracking control on the welding torch by correcting the positional coordinates of the welding torch based on the shift amount.

Patent Literature 2 discloses a simpler automatic-groove-tracking welding device and method that can be used in a wider range and that can better cope with disturbances and situational changes. This device includes an imaging device that acquires a video of a weld section from slightly above the front side of the welding torch, an image processing device that processes the video output from the imaging device and defines a high-brightness arc region, a computation device that calculates the position of the welding torch from the shape characteristics of the high-brightness arc region based on the positional relationship between the welding torch and the groove preliminarily obtained and stored in a storage device and the relationship of the shape characteristics of the high-brightness arc region, and a control device that adjusts the welding torch to an appropriate position based on the calculated position of the welding torch.

### CITATION LIST

### Patent Literature

PTL 1: Japanese Unexamined Patent Application Publication No. 2016-55344
PTL 2: Japanese Unexamined Patent Application Publication No. 2004-42067

### SUMMARY OF INVENTION

### Technical Problem

As indicated in the techniques according to Patent Literatures 1 and 2, weld-line tracking control employing image processing is extremely highly versatile. However, in view of the large volume of one piece of image data and the image processing speed, the frame rate of the imaging device inevitably needs to be reduced. This results in lower sampling frequency and lower accuracy in the weld-line tracking control, as compared with other types of weld-line tracking control, such as arc sensor. In particular, when a stoppage period (also referred to as “end stoppage time” hereinafter) is provided at a weaving end during weaving, the end stoppage time becomes unascertainable due to the sampling frequency becoming too low. This makes it difficult to ascertain the position of the weaving end, and a decrease in the accuracy of weld-line tracking is unavoidable. Therefore, it is desirable to provide a technique that can achieve highly-accurate weld-line tracking control even when the sampling frequency is low.

Accordingly, an object of the present invention is to provide a weaving control method, a welding control device, a welding system, a program, and a welding method that can achieve highly-accurate tracking control in weld-line tracking control employing image processing.

### Solution to Problem

The present invention includes the following configurations.

(1) A weaving control method for causing a welding torch to perform weaving based on command information, the weaving control method comprising:
a step for acquiring first weaving information from the command information, the first weaving information including information about a torch position during the weaving;
a step for acquiring second weaving information from image information at every predetermined sampling period, the image information being obtained by capturing an image of an area surrounding a tip of the welding torch during welding, the second weaving information including information about a welding center position and the torch position during the weaving in a weaving width direction orthogonal a weld line;
a step for setting a first stoppage period and a second stoppage period when the welding torch moves toward one side and an other side with respect to a center in the weaving width direction, the first stoppage period including a timing for stopping at a weaving end at the one side, the second stoppage period including a timing for stopping at a weaving end at the other side;
a step for calculating a representative value of a relative displacement amount between the welding center position and the torch position in each of the first stoppage period and the second stoppage period at every weaving cycle based on the second weaving information; and
a step for calculating a correction amount for weld-line tracking in accordance with an in-cycle displacement amount at every weaving cycle, the in-cycle displacement amount being determined based on the representative value of the relative displacement amount in the first stoppage period and the representative value of the relative displacement amount in the second stoppage period.

(2) A welding control device having a function for performing weaving control on a welding torch based on command information, the welding control device comprising:
a first information acquirer that acquires first weaving information from the command information, the first weaving information including information about a torch position during weaving;
a second information acquirer that acquires second weaving information from image information at every predetermined sampling period, the image information being obtained by capturing an image of an area surrounding a tip of the welding torch during welding, the second weaving information including information about a welding center position and the torch position during the weaving in a weaving width direction orthogonal a weld line;
a stoppage-period setting unit that sets a first stoppage period and a second stoppage period when the welding torch moves toward one side and an other side with respect to a center in the weaving width direction, the first stoppage period including a timing for stopping at a weaving end at the one side, the second stoppage period including a timing for stopping at a weaving end at the other side;
a relative-displacement-amount calculator that calculates a representative value of a relative displacement amount between the welding center position and the torch position in each of the first stoppage period and the second stoppage period at every weaving cycle based on the second weaving information; and
a correction amount calculator that calculates a correction amount for weld-line tracking in accordance with an in-cycle displacement amount at every weaving cycle, the in-cycle displacement amount being determined based on the representative value of the relative displacement amount in the first stoppage period and the representative value of the relative displacement amount in the second stoppage period.

(3) A welding system comprising:
the welding control device according to (2);
an imaging device that captures the image of the area surrounding the tip of the welding torch during the welding; and
a welding device that changes a welding condition based on the correction amount for the weld-line tracking output from the weaving control device.

(4) A program for executing a procedure of a weaving control method for causing a welding torch to perform weaving based on command information, the program causing a computer to execute:
a step for acquiring first weaving information from the command information, the first weaving information including information about a torch position during the weaving;
a step for acquiring second weaving information from image information at every predetermined sampling period, the image information being obtained by capturing an image of an area surrounding a tip of the welding torch during welding, the second weaving information including information about a welding center position and the torch position during the weaving in a weaving width direction orthogonal a weld line;
a step for setting a first stoppage period and a second stoppage period when the welding torch moves toward one side and an other side with respect to a center in the weaving width direction, the first stoppage period including a timing for stopping at a weaving end at the one side, the second stoppage period including a timing for stopping at a weaving end at the other side;
a step for calculating a representative value of a relative displacement amount between the welding center position and the torch position in each of the first stoppage period and the second stoppage period at every weaving cycle based on the second weaving information; and
a step for calculating a correction amount for weld-line tracking in accordance with an in-cycle displacement amount at every weaving cycle, the in-cycle displacement amount being determined based on the representative value of the relative displacement amount in the first stoppage period and the representative value of the relative displacement amount in the second stoppage period.

(5) A welding method comprising a control step for performing welding under a welding condition corrected in accordance with the weaving control method according to (1).

### Advantageous Effects of Invention

According to the present invention, highly-accurate tracking control can be achieved in weld-line tracking control employing image processing.

### BRIEF DESCRIPTION OF DRAWINGS

FIG. 1 schematically illustrates a configuration example of a welding system according to an embodiment.

FIG. 2 is a flowchart illustrating a procedure of robot control performed by a robot control device.

FIG. 3 is a perspective view illustrating the disposition of an imaging device.

FIG. 4 illustrates an image indicating an example of a welding image captured by the imaging device in the case of horizontal-position welding.

FIG. 5 is a block diagram illustrating a configuration example of a data processing device.

FIG. 6 illustrates an example of a screen used in a teaching operation.

FIG. 7 illustrates a specific example of a welding image obtained from horizontal-position welding, as well as an example of welding information within the welding image.

FIG. 8 illustrates a weaving trajectory obtained from the relationship between a torch position during weaving and time at every sampling period.

FIG. 9 illustrates the weaving trajectory provided with a rise phase and a fall phase of a weaving operation.

FIG. 10 illustrates a waveform of a signal output to the data processing device.

FIG. 11 illustrates a waveform indicating a command signal given to a stepping motor and an actual torch trajectory.

FIG. 12 illustrates another waveform of the signal output to the data processing device.

FIG. 13 illustrates another waveform of the signal output to the data processing device.

FIG. 14 illustrates another waveform of the signal output to the data processing device.

FIG. 15 is a graph illustrating the relationship between the torch position obtained from the welding image and time.

FIG. 16 illustrates how first weaving information and second weaving information are synchronized.

FIG. 17 illustrates the torch position according to the first weaving information and a waveform of a relative displacement amount according to the second weaving information.

FIG. 18 is a flowchart illustrating a procedure for calculating a tracking correction amount.

### DESCRIPTION OF EMBODIMENTS

A welding system according to an embodiment of the present invention will be described below with reference to the drawings. In the drawings, identical elements have corresponding relationships by being given the same reference signs. The welding system according to the present invention is suitable for use in a portable welding robot, but is not limited to the configuration of this embodiment. For example, a six-axis welding robot or a welding device having a drive section, such as a carriage, is also possible. Although horizontal-position single-sided welding is selected as an example in this embodiment, the execution method and the welding position are not particularly limited thereto.

Furthermore, in this embodiment, as will be described later, an image of at least a molten pool during welding is captured to be included in image data, and feature points related to the molten pool, a welding wire, and an arc are extracted. Although the extraction method of these feature points is not particularly limited, the feature points are extracted using a learning device in this embodiment.

### Configuration of Welding System

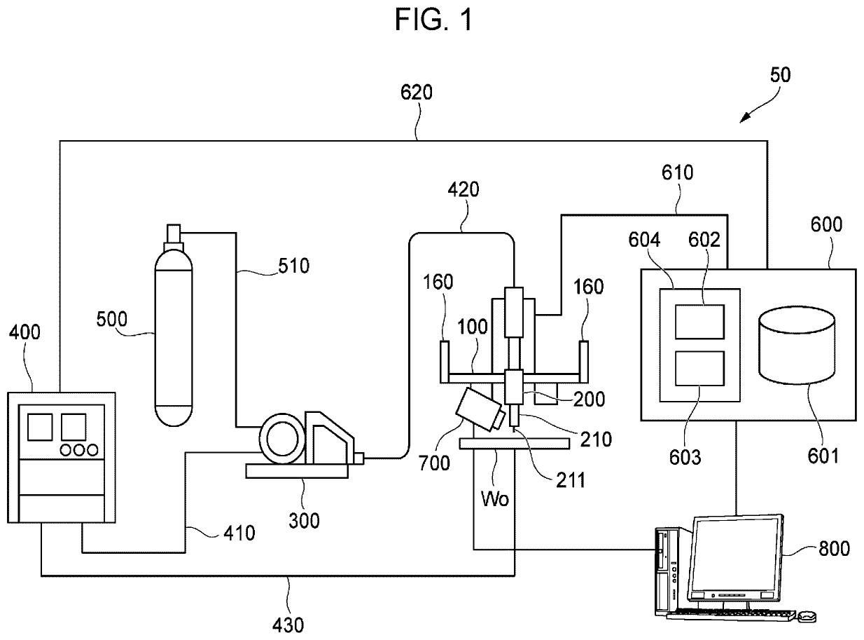

FIG. 1 schematically illustrates a configuration example of the welding system according to this embodiment. As shown in FIG. 1, a welding system 50 includes a portable welding robot 100, a feeding device 300, a welding power source 400, a shielding-gas supply source 500, a robot control device 600, an imaging device 700, and a data processing device 800. If the features of this embodiment are applied to a six-axis welding robot or a welding device having a drive section, such as a carriage, as mentioned above, further components may be included to accord with the components thereof.

The components included in the welding system 50 are communicably connected by any of various types of wired or wireless communication methods. The communication method is not limited to a single method, and the connection may be possible with a combination of multiple communication methods.

### Robot Control Device

The robot control device 600 is connected to the portable welding robot 100 by a robot control cable 610, and is connected to the welding power source 400 by a power-source control cable 620. The robot control device 600 has a data retainer 601 that preliminarily retains teaching data in which, for example, the movement pattern, the welding start position, the welding end position, the execution condition, and the welding condition of the portable welding robot 100 are set. The robot control device 600 transmits command information as a command to the portable welding robot 100 and the welding power source 400 based on this teaching data, so as to control the movement and the welding condition of the portable welding robot 100.

The robot control device 600 may have a groove-shape-information calculator 602 that calculates groove shape information from detection data obtained by performing sensing, such as touch sensing, prior to welding, and may also have a welding condition acquirer 603 that corrects and acquires the welding condition in the teaching data based on the groove shape information. The groove-shape-information calculator 602 and the welding condition acquirer 603 constitute a control unit 604.

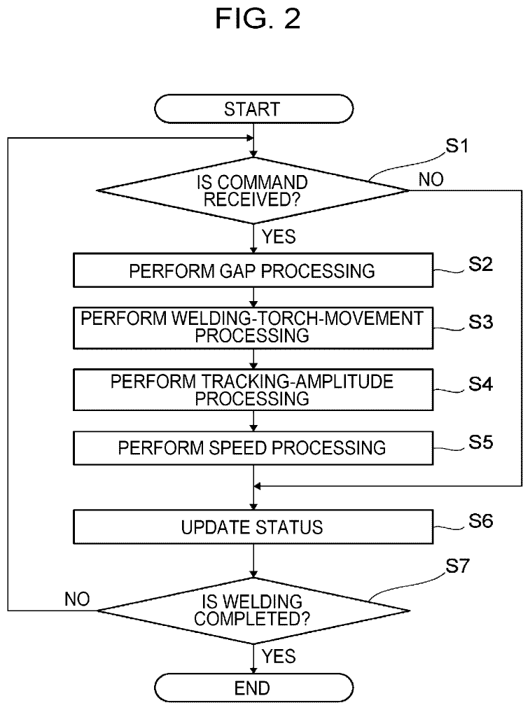

As indicated in a robot control procedure in FIG. 2, during welding after the start of welding performed under the welding condition in the teaching data corrected by sensing, the robot control device 600 extracts feature points at the data processing device 800 based on the image data acquired from the imaging device 700, as will be described later. Then, a correction signal of various processes is received as command information (also referred to as a command hereinafter) from information about each feature point (S1). The robot control device 600 sequentially executes control, such as gap processing (S2), welding-torch-movement processing (S3), tracking-amplitude processing (S4), and speed processing (S5), to be described in detail later. Accordingly, each type of control processing is performed in accordance with the correction signal received during welding, and status update information about each type of control condition is output to the data processing device 800 (S6). The above processes (S1 to S6) are repeated (S7) until the target welding is completed.

Furthermore, the robot control device 600 illustrated in FIG. 1 has a controller (also referred to as “teaching pendant” hereinafter) for performing teaching and for manually controlling the portable welding robot 100, and also has a controller having other control functions. The controllers may be integrated into a single unit, the controllers may be multiple divided units depending on the roles thereof, such as two divided units as in the teaching pendant and the controller having the other control functions, or the robot control device 600 may be included in the portable welding robot 100. From the standpoint of usability at a welding site, the controllers are preferably two divided units, that is, the controller for performing teaching and for manually controlling the portable welding robot 100 and the controller having the other control functions. Thus, in this embodiment, the controllers are two divided units, that is, the teaching pendant and the controller having the other control functions, and the teaching pendant (not shown) and the robot control device 600 are connected by a communication cable. Although a signal is transmitted by using the robot control cable 610 and the power-source control cable 620 in this embodiment, the configuration is not limited to this, and the signal may be transmitted wirelessly.

### Welding Power Source

The welding power source 400 supplies electric power to a welding wire 211 as a consumable electrode and to a workpiece Wo in accordance with a command from the robot control device 600, so as to generate an arc between the welding wire 211 and the workpiece Wo. The electric power from the welding power source 400 is transmitted to the feeding device 300 via a power cable 410, and is transmitted to a welding torch (referred to as “torch” hereinafter) 200 from the feeding device 300 via a conduit tube 420. Then, the electric power from the welding power source 400 is supplied to the welding wire 211 via a contact tip at the tip of the torch 200. The electric current during the welding operation may be a direct current or an alternating current, and the waveform thereof is not particularly limited. Therefore, the electric current may be, for example, a rectangular wave or triangular wave pulse.

With regard to the welding power source 400, for example, the power cable 410 is connected as a positive electrode to the torch 200 side, and a power cable 430 is connected as a negative electrode to the workpiece Wo. This is a case where the welding is performed with reversed polarities. In a case where the welding is performed with a positive polarity, the power cable as the positive electrode may be connected to the workpiece Wo side, whereas the power cable as the negative electrode may be connected to the torch 200 side.

### Shielding-Gas Supply Source

The shielding-gas supply source 500 is constituted of a container hermetically containing a shielding gas therein and an auxiliary member, such as a valve. The shielding gas is delivered from the shielding-gas supply source 500 to the feeding device 300 via a gas tube 510. The shielding gas delivered to the feeding device 300 is delivered to the torch 200 via the conduit tube 420. The shielding gas delivered to the torch 200 flows through the torch 200, is guided to a nozzle 210, and is ejected from the tip of the torch 200. The shielding gas used in this embodiment may be, for example, argon gas (Ar), carbon dioxide gas (CO₂), or a mixture thereof.

The conduit tube 420 according to this embodiment has a conducting path functioning as a power cable at the outer sheath of the tube and has a protecting tube for protecting the welding wire 211 inside the tube, so that a shielding-gas flow path is formed. However, the conduit tube 420 used is not limited to this and may be, for example, a bundle of a power supply cable and a shielding-gas supply hose bound around a protecting tube for feeding the welding wire 211 to the torch 200. Alternatively, for example, the welding wire 211, a shield-gas feeding tube, and the power cable may be disposed individually.

### Feeding Device

The feeding device 300 feeds the welding wire 211 to the torch 200. The welding wire 211 to be fed by the feeding device 300 is not particularly limited and may be selected in accordance with, for example, the properties and the welding form of the workpiece Wo.

For example, a solid wire or a flux-cored wire may be used. Although the wire diameter of the welding wire is not particularly limited, a preferred wire diameter in this embodiment is 1.6 mm as an upper limit and 0.9 mm as a lower limit.

The conduit tube 420 according to this embodiment has a conducting path functioning as a power cable at the outer sheath of the tube and has a protecting tube for protecting the welding wire 211 inside the tube, so that a shielding-gas flow path is formed. However, the conduit tube 420 used is not limited to this and may be, for example, a bundle of a power supply cable and a shielding-gas supply hose bound around a protecting tube for feeding the welding wire 211 to the torch 200. Alternatively, for example, the welding wire 211, a shield-gas feeding tube, and the power cable may be disposed individually.

In this embodiment, voltage is applied between the workpiece Wo and the welding wire 211, and a touch sensor that detects, for example, the surface of a groove 10 by utilizing a voltage drop phenomenon occurring when the welding wire 211 comes into contact with the workpiece Wo serves as detection means. The detection means is not limited to the touch sensor according to this embodiment and may be, for example, an image sensor, a laser sensor, or a combination of these types of detection means. However, the touch sensor according to this embodiment is preferable in terms of a simple device configuration.

### Imaging Device

The imaging device 700 (also referred to as “camera” hereinafter) is constituted of a camera equipped with a CCD (charge coupled device) as a visual sensor. The disposition of the imaging device 700 is not particularly limited. The imaging device 700 may be directly attached to the portable welding robot 100 or may be fixed as a monitoring camera to a specific peripheral location. If the imaging device 700 is directly attached to the portable welding robot 100, the imaging device 700 moves to capture an image of the area surrounding the tip of the torch 200 together with the movement of the portable welding robot 100. The number of cameras constituting the imaging device 700 may be plural. For example, the imaging device 700 may be constituted of a plurality of cameras having different functions and installed at different locations.

The direction in which the imaging device 700 captures an image is also not particularly limited. For example, if the welding proceeds in the forward direction, the imaging device 700 may be disposed to capture an image of the front side, or may be disposed to capture an image of a lateral side or the rear side. Therefore, the imaging range of the imaging device 700 may be set as appropriate. In order to suppress interference of the torch 200, it is preferable that an image be captured from the front side. In this embodiment, an image is captured from the front side. The captured image information is transmitted to the data processing device 800 so as to be used in the data processing device 800. In this case, for example, the data processing device 800 may load an arbitrary image at a predetermined interval from the captured image information and use the image in processing to be described later. The load method and the load setting may be changed in accordance with, for example, the configuration and the function of the imaging device 700 and the performance of the data processing device 800.

In this embodiment, the imaging device 700 directly attached and fixed to the portable welding robot 100 is used to capture a moving image as a welding image such that an imaging range at least including the workpiece Wo, the welding wire 211, and the arc as objects (targets) included in the image data is set. Various imaging settings related to the welding image may be defined in advance or may be changed in accordance with the operational conditions of the welding system 50. Examples of the imaging settings include the frame rate, the number of pixels in the image, the resolution, and the shutter speed.

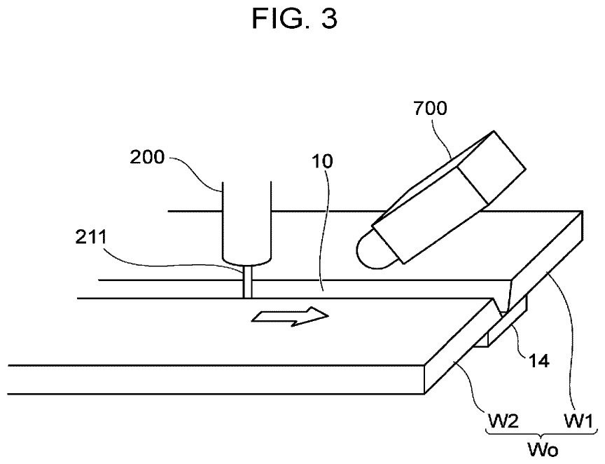

FIG. 3 is a perspective view illustrating the disposition of the imaging device 700. Because the orientations of the torch 200 and the groove vary depending on the welding position, the orientations illustrated in FIG. 3 are examples. In this embodiment, the workpiece Wo is a butt joint. The workpiece Wo includes two metallic plates butt-jointed with a groove interposed therebetween. In this embodiment, the horizontal position is described as an example. In this case, a workpiece at the upper plate side will be indicated as W1 (referred to as an upper plate W1 hereinafter), whereas a workpiece at the lower plate side will be indicated as W2 (referred to as a lower plate W2 hereinafter). A ceramic backing member 14 is attached to the underside of the two butt-jointed workpieces W1 and W2. The backing member 14 used may be a metallic backing member, or a configuration not provided with a backing member is also possible. Therefore, the material of the backing member is not particularly limited, and may be varied in accordance with, for example, the material of the workpiece Wo. In a butt joint, arc welding is performed in one direction along the groove. The direction in which the welding proceeds will be referred to as “weld line direction” below. In FIG. 3, the direction in which the welding proceeds is indicated with an arrow. Thus, the torch 200 is located behind the imaging device 700.

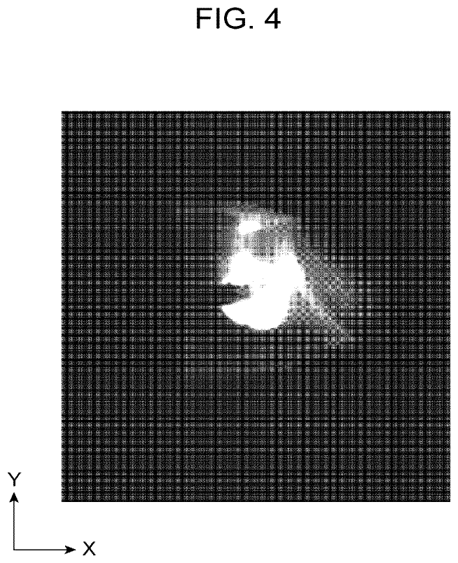

FIG. 4 illustrates an image indicating an example of a welding image captured by the imaging device 700 in the case of horizontal-position welding. Each piece of image data in FIG. 4 serves as a coordinate plane having coordinates and having two axes, that is, an X axis and a Y axis. The X axis indicates the weld line direction, whereas the Y axis indicates a direction orthogonal to the X axis.

The imaging device 700 captures an image of a range including the welding position of the workpiece Wo during arc welding. In addition to a molten pool, the image includes the welding wire 211 and an arc.

For example, the visual sensor of the imaging device 700 according to this embodiment can successively capture still images of 1024×768 pixels. In other words, the imaging device 700 can capture the welding image as a moving image. The resolution of each still image that can be captured by the imaging device 700 is not particularly limited. For example, if the imaging device 700 is constituted of a plurality of cameras, the plurality of cameras may acquire welding images with different resolutions. Furthermore, pre-processing may be performed for cutting out an arbitrary feature region from a welding image captured for the purpose of shortening the processing time before being input to a learned model, to be described later. The arbitrary feature region may be a range with a fixed size in which a predetermined region is disposed at the center. The size of the arbitrary feature region may be changed in accordance with the welding status.

### Data Processing Device

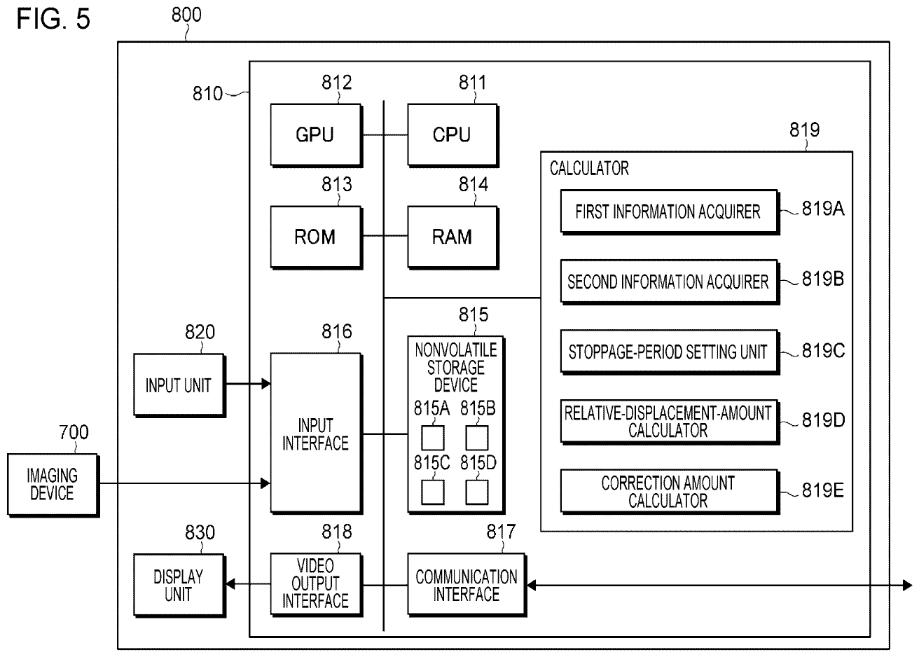

FIG. 5 is a block diagram illustrating a configuration example of the data processing device 800. The data processing device 800 is constituted of, for example, a computer. The computer includes a main unit 810, an input unit 820, and a display unit 830. The main unit 810 includes a CPU 811, a GPU (graphical processing unit) 812, a ROM 813, a RAM 814, a nonvolatile storage device 815, an input-output interface 816, a communication interface 817, a video output interface 818, and a calculator 819. The CPU 811, the GPU 812, the ROM 813, the RAM 814, the nonvolatile storage device 815, the input-output interface 816, the communication interface 817, the video output interface 818, and the calculator 819 are connected in a communicable manner by a bus or a signal line.

The nonvolatile storage device 815 has stored therein a learning program 815A that executes deep learning by using predetermined learning data, a learned model 815B generated by executing the learning program 815A, an information generating program 815C that generates welding information related to welding by using the learned model 815B, and image data 815D. In addition, an operating system and an application program are installed in the nonvolatile storage device 815.

By causing the CPU 811 and the GPU 812 to execute a program, the data processing device 800 implements various types of functions. In this embodiment, the data processing device 800 implements a function for generating a learned model by machine learning and a function for performing various processes during actual welding by using the learned model. The details of these functions will be described later. The data processing device 800 may be divided in accordance with the function for generating a learned model and the function for executing a control process based on information output from the learned model during the execution of actual welding. From the standpoint of versatility, it is more preferable that the data processing device 800 be divided in accordance with the respective functions. The GPU 812 is used as a computation device when the learning program 815A and the information generating program 815C are executed. The ROM 813 has stored therein, for example, BIOS (basic input output system) executed by the CPU 811. The RAM 814 is used as a work area for a program loaded from the nonvolatile storage device 815.

The input-output interface 816 is connected to the input unit 820 constituted of, for example, a keyboard and a mouse. The input-output interface 816 is also connected to the imaging device 700. Image data output from the imaging device 700 is transmitted to the CPU 811 via the input-output interface 816. The communication interface 817 is a communication module for wired or wireless communication. The video output interface 818 is connected to the display unit 830 constituted of, for example, a liquid crystal display or an organic EL (electro-luminescence) display, and outputs a video signal according to video data transmitted from the CPU 811 to the display unit 830. The calculator 819 operates in cooperation with the CPU 811 and the GPU 812 to execute various processes, such as calculation of a weld-line-tracking correction amount according to this embodiment.

The calculator 819 includes a first information acquirer 819A, a second information acquirer 819B, a stoppage-period setting unit 819C, a relative-displacement-amount calculator 819D, and a correction amount calculator 819E. The processing in each unit of the calculator 819 will be described in detail later, but is generally as follows.

The first information acquirer 819A acquires, from command information, first weaving information including information about a torch position during weaving.

The second information acquirer 819B acquires, from image information about a captured image of an area surrounding the tip of the torch 200 during weaving, second weaving information at every predetermined sampling period. The second weaving information includes information about the welding center position and the torch position during the weaving in a weaving width direction orthogonal to the weld line.

The stoppage-period setting unit 819C sets a first stoppage period and a second stoppage period when the torch 200 moves toward one side and toward the other side with respect to the center in the weaving width direction. The first stoppage period includes a timing for stopping at a weaving end at the one side. The second stoppage period includes a timing for stopping at a weaving end at the other side.

The relative-displacement-amount calculator 819D calculates a representative value of a relative displacement amount between the welding center position and the torch position in each of the first stoppage period and the second stoppage period at every weaving cycle based on the second weaving information.

The correction amount calculator 819E calculates, at every weaving cycle, a weld-line-tracking correction amount in accordance with an in-cycle displacement amount determined based on the representative value of the relative displacement amount in the first stoppage period and the representative value of the relative displacement amount in the second stoppage period.

The data processing device 800 described above functions as a welding control device having a function for performing weaving control on the welding torch based on command information.

### Generation of Learning Model

The feature points extracted from the image data and the learned model for extracting the feature points in this embodiment will now be described. The learned model 815B according to this embodiment is constituted of a convolutional neural network and includes a plurality of convolutional layers and a plurality of pooling layers. The convolutional neural network is not limited to the above configuration, and may have a different number of layers and a different configuration.

In a description related to a learning device below, the terms “learning” or “machine learning” refers to generation of a “learned model” by performing learning using learning data and an arbitrary learning algorithm. The learned model is updated on a timely basis as the learning progresses using multiple pieces of learning data, and the output changes even when the input is the same. Therefore, the learned model is not to limit the status at any given time point. A model used in learning will be described as “learning model”, and a learning model having undergone a certain degree of learning will be described as “learned model”. Although a specific example of “learning data” will be described later, the configuration thereof may be changed in accordance with the learning algorithm used. The learning data may include training data used in the actual learning, validation data used for validating the learned model, and test data used for testing the learned model. In the following description, the term “learning data” will be used when comprehensively indicating learning-related data, whereas the term “training data” will be used to indicate data when performing the actual learning. This is not intended to clearly classify the training data, the validation data, and the test data included in the learning data. For example, depending on the learning, validation, and testing methods, the learning data may entirely be training data.

The learned model 815B receives image data output from the imaging device 700 and outputs feature points related to various types of welding information appearing in the image data. As shown in FIG. 4, in this embodiment, the image data input to the learned model 815B at least includes a molten pool, a welding wire, and an arc as objects (targets) , and feature points obtained from these objects or from between multiple objects are extracted. Based on the extracted feature points, the calculator 819 calculates a tracking correction amount, to be described later, and correction amounts for the amplitude, the welding speed, the trajectory (angle) of the welding torch, and so on, and transmits the information about the obtained correction amounts to the robot control device 600. The image data may also be referred to as a welding image hereinafter.

In this embodiment, the leading end (wire tip) of the welding wire 211, the center point (arc center) of the arc, the positions of the left and right (or upper and lower) leading ends of the molten pool, and the positions of the left and right (or upper and lower) ends of the molten pool are used as the feature points related to the welding information. A feature point used as training data is input by an operator designating a specific location on the welding image in accordance with an instruction on an operation screen for assisting a teaching operation. Therefore, the training data is constituted of a pair of the welding image and the feature point serving as coordinate information as the welding information designated by the operator. The learning process involves comparing the welding information output from the learning model with the welding information included in the training data and feeding back an error therebetween to adjust a parameter. By repeating this process, the learning progresses.

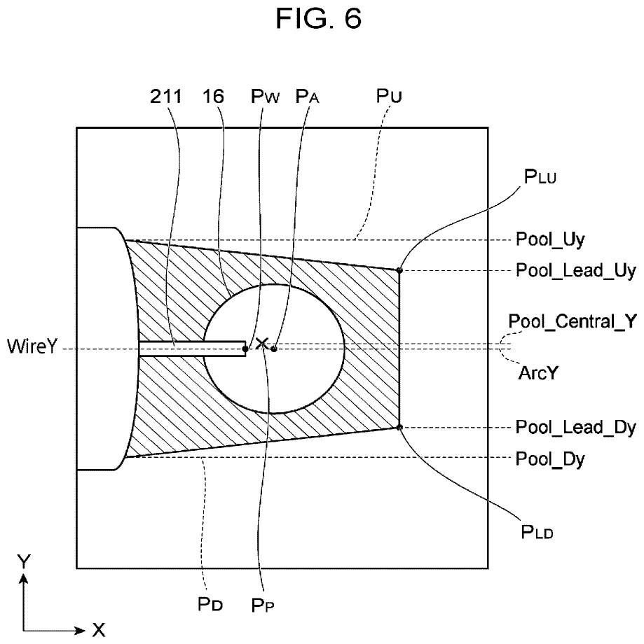

FIG. 6 illustrates an example of a screen used in a teaching operation. The welding image on the screen shown in FIG. 6 includes a molten pool 15, the welding wire 211, and an arc 16. In FIG. 6, the molten pool 15 is shaded. In a description related to FIG. 6, the terms “upper end” and “lower end” simply indicate upper and lower sides in the image and may be replaced with, for example, the terms “right end” and “left end” in accordance with the welding position and the orientation of the image.

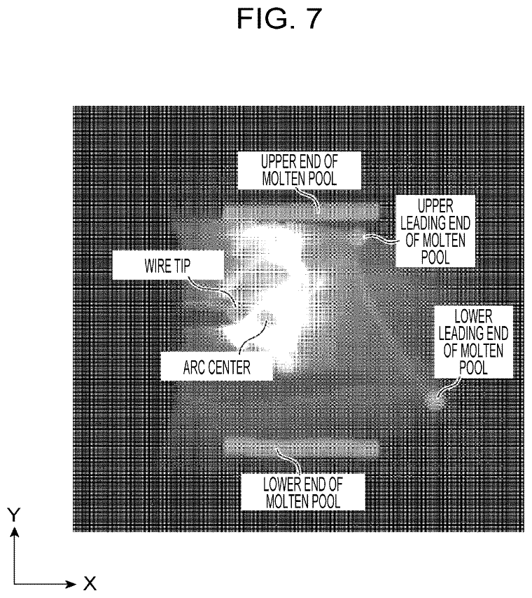

FIG. 7 illustrates a specific example of a welding image obtained from horizontal-position welding, as well as an example of welding information within the welding image. In order to simplify the illustration, positions corresponding to the coordinates indicated at the feature points are rendered on the welding image. As mentioned above, the image serves as a coordinate plane having coordinates and having two axes, that is, the X axis and the Y axis.

In this embodiment, since the imaging device 700 is disposed such that the weld line direction and the X-axis direction are parallel to each other, the X-axis direction may be rephrased as the weld line direction in this embodiment. Furthermore, the Y-axis direction is perpendicular to the X axis. In other words, the Y-axis direction serves as a groove width direction that is perpendicular to the weld line, so that the Y-axis direction may be rephrased as the groove width direction. Since the X axis along which the portable robot according to this embodiment moves serves as the weld line direction, the X axis along which the portable robot moves and the X axis on the welding image extend in the same direction. With regard to the Y-axis direction, the Y axis along which the portable robot moves and the Y axis on the welding image also extend in the same direction.

In this embodiment, as shown in FIG. 6, the feature points taught by the operator are a coordinate position P_{A} (ArcX, ArcY) of the arc center, a coordinate position P_{W} (WireX, WireY) of the wire tip, a coordinate position P_{LD} (Pool_Lead_Dx, Pool_Lead_Dy) of the molten-pool lower leading end, a coordinate position P_{LU} (Pool_Lead_Ux, Pool_Lead_Uy) of the molten-pool upper leading end, a coordinate position P_{D} (Pool_Dy) of the molten-pool lower end, and a coordinate position P_{U} (Pool_Uy) of the molten-pool upper end. The feature points are input by the operator designating specific locations on the screen. The coordinates indicating the boundary between the welding wire 211 and the arc are an example of positional coordinates of the wire tip. The molten-pool lower leading end, the molten-pool upper leading end, the molten-pool lower end, and the molten-pool upper end are examples of feature points related to the behavior of the molten pool 15. For example, when the feature points of the molten-pool lower end and the molten-pool upper end are ascertained, the width of the molten pool 15 can be calculated.

### Calculation of Tracking Correction Amount

The tracking correction amount in this embodiment is calculated based on weaving data (also referred to as second weaving information hereinafter) calculated in accordance with weaving robot coordinate data (also referred to as first weaving information hereinafter), which is calculated based on a weaving command value output from the robot control device 600 to a stepping motor of the portable welding robot, and the feature points on the welding image captured by the imaging device 700. As mentioned above, calculating the correction amount for the weld-line tracking control only based on the second weaving information serving as the weaving data based on the welding image results in lower sampling frequency and lower accuracy, as compared with other types of weld-line tracking control, such as arc sensor. On the other hand, the first weaving information serving as the weaving robot coordinate data has a high sampling frequency but is not applicable to tracking control since the center position as the welding target position is not ascertainable. Thus, in this embodiment, the tracking correction amount is calculated from the second weaving information by using the first weaving information with the high sampling frequency, as described in detail below. Although the following process is performed in a robot coordinate system, the coordinate system is not limited thereto.

### First Weaving Information

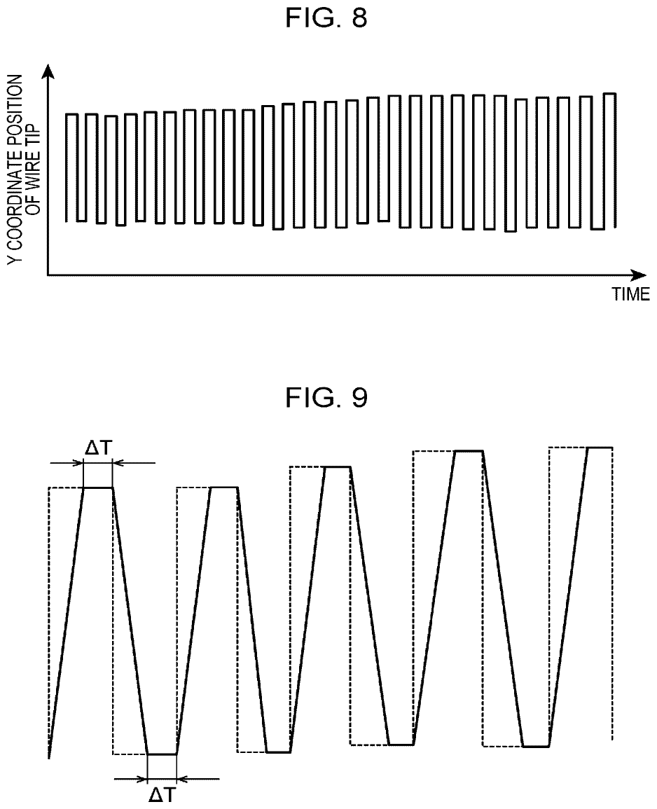

The first weaving information is information obtained by calculating the torch position during weaving based on the robot coordinates. To be precise, the torch position in this case refers to the wire tip position serving as a target position for the tip of the welding wire 211. In this embodiment, the first information acquirer 819A calculates the torch position based on command information given to the stepping motor responsible for the weaving operation of the portable welding robot in the robot control device 600. As shown in FIG. 8, each period of a command signal given to the stepping motor may be set as a sampling period, and the weaving trajectory may be determined from the relationship between the torch position during weaving and time at every sampling period. Since weaving information of the robot coordinates is generated from the command information given to the stepping motor in this embodiment, the torch position cannot be captured when the torch moves from one weaving end to the other weaving end. Therefore, as shown in FIG. 8, the weaving trajectory is calculated as rectangular waves.

If the welding torch movement according to the above-described weaving operation stops for a predetermined time (weaving-end stoppage time ΔT) at a weaving end, a rise phase and a fall phase of the weaving operation may be provided based on this preset weaving-end stoppage time ΔT. In that case, as shown in FIG. 9, a waveform indicated with a solid line with the weaving trajectory corrected from the rectangular-wave trajectory indicated with a dashed line is obtained. This waveform is defined as the first weaving information serving as the weaving data of the robot coordinates mentioned above.

On the other hand, if the weaving operation does not have the weaving-end stoppage time ΔT set therein, that is, if the weaving operation to be performed does not involve an end stoppage (ΔT =0), the value of ΔT is calculated in a calculation process for the in-cycle displacement amount, to be described later, by using a predetermined fixed value as the weaving stoppage time. For example, in a condition where the weaving operation does not involve an end stoppage, the fixed value is preliminarily set to a value selected from a range between 100 and 200 msec, and a waveform provided with a time period equivalent to the fixed value is created such as to include a time point at which the torch position is located at an end point in the original robot-coordinate weaving data. Then, the in-cycle displacement amount is calculated with the fixed value set as the weaving-end stoppage time ΔT.

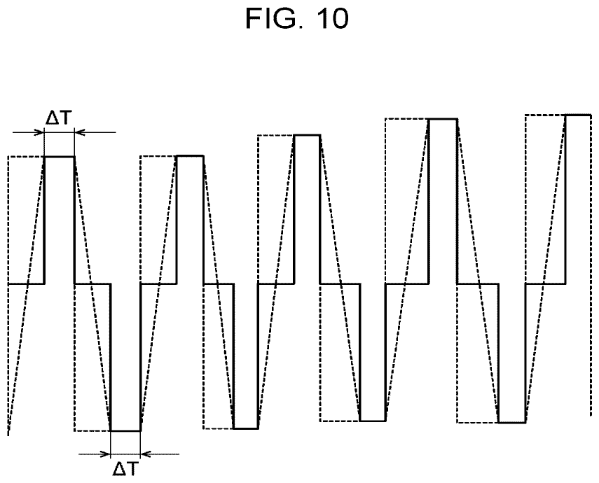

The aforementioned weaving-end stoppage time ΔT is set by the stoppage-period setting unit 819C. As will be described later, in this embodiment, the robot control device 600 outputs, to the data processing device 800, a signal in which the waveform shown in FIG. 8 has been replaced by a waveform shown in FIG. 10 where only the part of each weaving-end stoppage time ΔT is a signal.

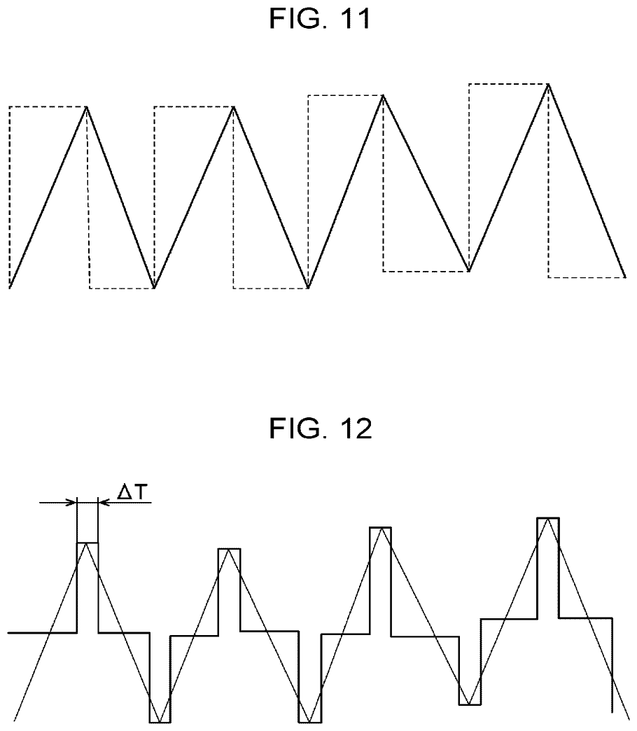

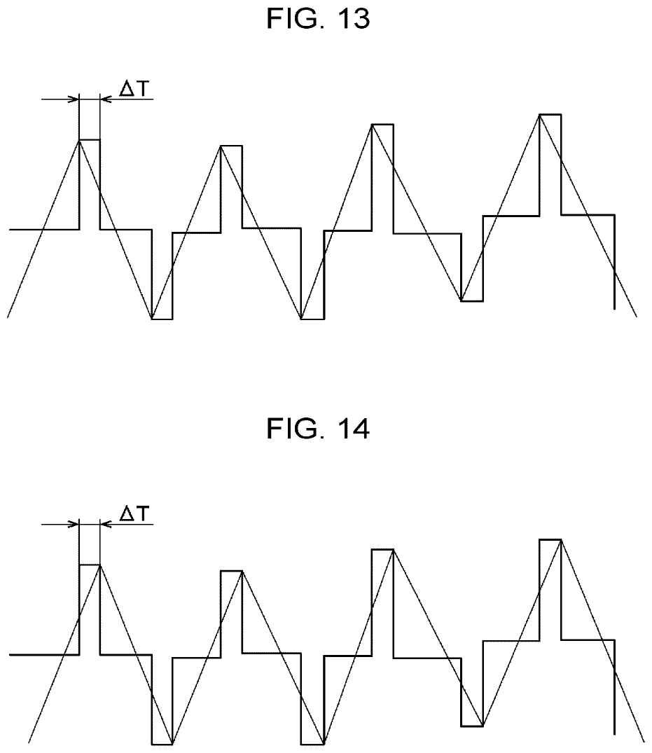

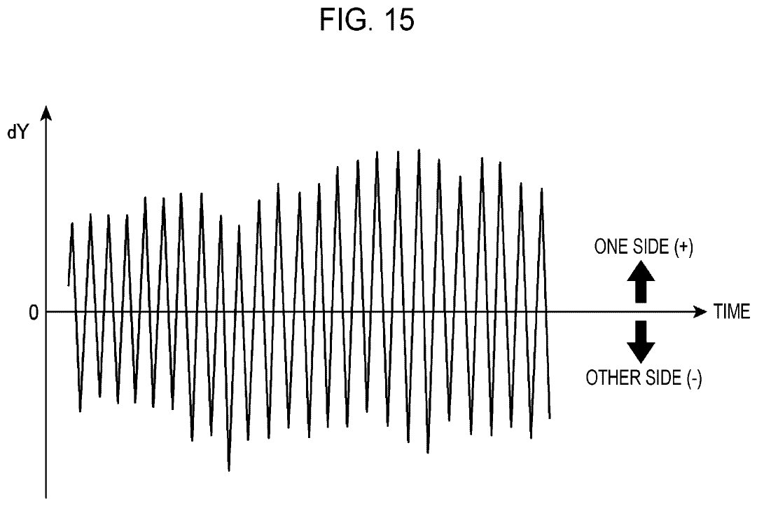

If the waveform of the weaving trajectory mentioned above is provided with the weaving-end stoppage time ΔT as a fixed value, each time period provided with the weaving-end stoppage time ΔT is not limited to a time period beginning from a timing at which the torch reaches a weaving end, as shown in FIG. 10. For example, if the actual torch trajectory is in the form of triangular waves indicated with a solid line relative to a command signal given to the stepping motor indicated with a dashed line shown in FIG. 11, the weaving-end stoppage time ΔT may be provided such as to be centered on a timing at which the actual torch reaches a weaving end, as shown in FIG. 12. Alternatively, the weaving-end stoppage time ΔT may be provided such as to begin from the timing at which the actual torch reaches a weaving end, as shown in FIG. 13, or the aforementioned arrival timing at the weaving end may be set as a terminal end, and the weaving-end stoppage time ΔT may be provided by backtracking from the terminal end, as shown in FIG. 14.

### Second Weaving Information

The second weaving information includes the torch position, determined based on the welding image, during weaving at every predetermined sampling period. The second weaving information is calculated by the second information acquirer 819B. The sampling period used here may be a period based on the frame rate of the Camera. In this embodiment, the torch position determined based on the welding image is calculated as a Y coordinate position (WireY) as the wire tip position serving as one of the feature points of the welding image. The torch position is not limited to the Y coordinate position (WireY) serving as the wire tip position, and may be, for example, a Y coordinate position (ArcY) of the arc center. Other than the frame rate, the sampling period may be a period that is an integer multiple of the frame rate.

In the case of the horizontal position when tracking correction control is to be performed, it is necessary to determine whether a deviation has occurred toward the upper plate (also referred to as one side hereinafter) or the lower plate (also referred to as the other side hereinafter) with respect to an arbitrary welding target position. The welding target position is normally the groove center position in the case of groove welding. In this embodiment, the welding target position is determined from the molten pool in the welding image. In detail, as shown in FIG. 6, a Y coordinate (Pool_Central_Y) of a molten-pool center position P_{P} is determined from the Y coordinate (Pool_Lead_Dy) of the coordinate position P_{LD} of the molten-pool lower leading end and the Y coordinate (Pool_Lead_Uy) of the coordinate position P_{UD} of the molten-pool upper leading end by using Expression 1 indicated below.

(Pool Central Y)={(Pool Lead Dy)+(Pool Lead Uy) }/2 (Expression (1)

Furthermore, the calculated Y coordinate (Pool Central Y) of the molten-pool center position P_{P} as the welding center position is defined as an origin position (0 position) by using Expression 1, and the torch position at the one side and the other side in the weaving width direction with respect to the center in the weaving width direction is adjusted based on Expression 2 indicated below. In this embodiment, the relative-displacement-amount calculator 819D calculates a relative displacement amount (dY) by using Expression 2, adjusts the wire tip position (WireY) toward the one side (upper side) if the calculated relative displacement amount (dY) is a positive value, and adjusts the wire tip position (WireY) toward the other side (lower side) if the calculated relative displacement amount (dY) is a negative value. The relationship between the relative displacement amount (dY) and time is as shown in FIG. 15. Data about the relative displacement amount (dY) serves as the second weaving information.

(dY)=(WireY)=(Pool Central Y) (Expression 2)

### Method for Calculating Tracking Correction Amount

Subsequently, the correction amount calculator 819E calculates the tracking correction amount in the following manner by using the first weaving information and the second weaving information described above.

### Synchronization Process

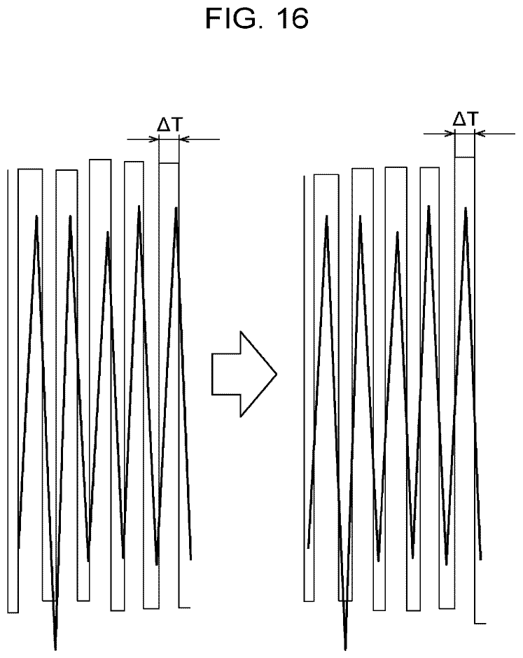

First, data waveforms of the first weaving information and the second weaving information are synchronized. The robot coordinate data serving as the first weaving information (e.g., the data in FIG. 10) is output from the robot control device 600 to the data processing device 800. Because the robot coordinate data in this case contains a delay time, this delay time is adjusted. Specifically, as shown in FIG. 16, the first weaving information and the second weaving information are synchronized on the time axis such that the peak of the waveform of the second weaving information is disposed in phase with the center of the weaving-end stoppage time ΔT in the first weaving information.

### Calculation of Relative Displacement Amount and In-Cycle Displacement Amount

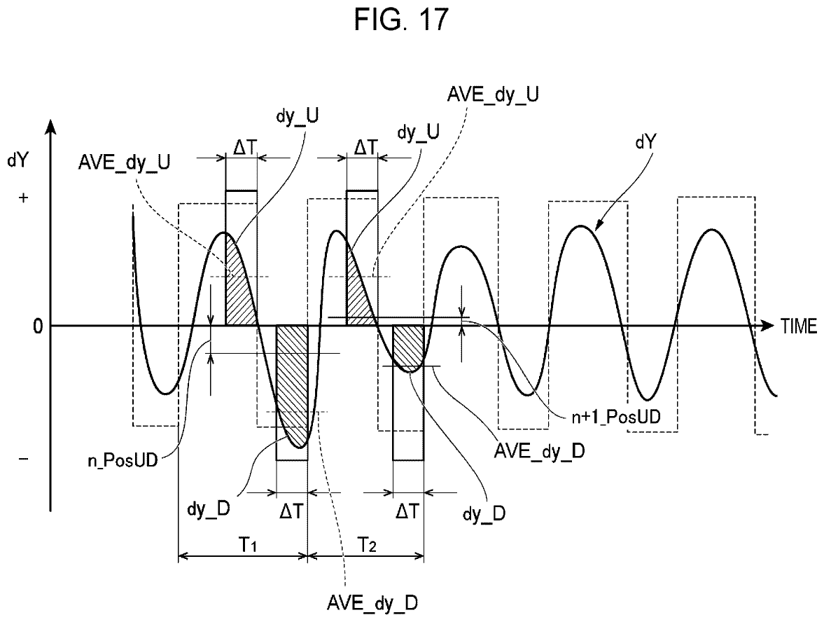

As shown in FIG. 17, at every weaving cycle T₁ (i being a positive integer), an average value (AVE_dy_U) is calculated as a representative value of a relative displacement amount dY (dy_U) at the upper side (positive value) in the end stoppage period ΔT described with reference to FIGS. 9, 10, and 12 to 14. Likewise, an average value (AVE_dy_D) is calculated as a representative value of a relative displacement amount dY (dy_D) at the lower side (negative value) in a subsequent end stoppage period ΔT. Then, as indicated in Expression 3 below, it is determined whether the torch is deviated toward the upper side or the lower side based on the average values (AVE_dy_U) and (AVE_dy_D) of the relative displacement amounts, and an in-cycle displacement amount (n_PosUD) in each weaving cycle is calculated from the difference therebetween. In this embodiment, the average value (AVE_dy_U) of the relative displacement amount is a positive value, whereas the average value (AVE_dy_D) of the relative displacement amount is a negative value. Therefore, if the in-cycle displacement amount (n_PosUD) is a positive value, there is a displacement equivalent to the value toward the upper side. If the in-cycle displacement amount (n_PosUD) is a negative value, there is a displacement equivalent to the value toward the lower side. Although each average value is calculated as a representative value in this embodiment, the value used is not limited thereto and may be, for example, a minimum value or a maximum value in the end stoppage time ΔT.

(n_PosUD)=(AVE_dy_U)+(AVE_dy_D) (Expression 3)

In a weaving cycle T₁, the absolute value of the average value (AVE_dy_U) of the relative displacement amount dY (dy_U) at the upper side is smaller than the absolute value of the average value (AVE_dy_D) of the relative displacement amount dY (dy_D) at the lower side. Therefore, the in-cycle displacement amount (n_PosUD) is at the lower side (negative side). This indicates a deviation toward the lower side relative to the welding center position. In a weaving cycle T₂, the absolute value of the average value (AVE_dy_U) of the relative displacement amount dY (dy_U) at the upper side is larger than the absolute value of the average value (AVE_dy_D) of the relative displacement amount dY (dy_D) at the lower side. Therefore, an in-cycle displacement amount (n+1_PosUD) is at the upper side (positive side). This indicates a deviation toward the upper side relative to the welding center position.

For calculation reasons, the in-cycle displacement amount may be multiplied by a correction coefficient M, as in Expression 4. By multiplying the correction coefficient M, an actual change in the relative displacement amount can be set to an appropriate magnitude level in calculation, so that responsiveness of control can be properly adjusted.

(n_PosUD)=[{(AVE_dy_U)+(AVE_dy_D) }×M] (Expression 4)

Each of the in-cycle displacement amounts (n_PosUD), (n+1_PosUD), and so on calculated in this manner by the data processing device 800 is output as one of commands to the robot control device 600. Instead of the representative value being an average value of a relative displacement amount dY in each end stoppage time ΔT described above, for example, the representative value may be a medium value, a maximum value, or a mode value.

### Calculation of Tracking Correction Amount

Although the in-cycle displacement amount (n_PosUD) calculated at every weaving cycle may be directly used as a tracking correction amount TC, there is a risk where the correction is performed with an unexpected value and the control is not performed properly due to, for example, a disturbance. In that case, as indicated by Expression 5, a moving average value (AVE_n_PosUD) between the displacement amount (n_PosUD) in the current cycle and the displacement amount (n−1_POSUD) in the previous cycle may be used. Furthermore, a value obtained by multiplying the moving average value (AVE_n_PosUD) by a predetermined gain value G may be calculated as the tracking correction amount TC, as in Expression 6. This tracking correction amount may be calculated as a distance (mm) that cancels the displacement amount. A coefficient k used may be, for example, a value of 0.5.

(AVE_n_PosUD)=(n_PosUD)×(1−k)+(n−1_PosUD)×k (Expression 5)

TC=(AVE_n_PosUD)×G (Expression 6)

### Limit Value for Tracking Correction Amount

From the standpoint of stable control, it is preferable that a predetermined limit value be provided for the calculated tracking correction amount TC. When a limit range is exceeded, the tracking correction amount TC used is a maximum or minimum correction amount of the limit range. For example, in the case where the limit range is between +α mm and −α mm, if the limit range is exceeded at the positive side, α mm is treated as a fixed value (a being an arbitrary value), whereas if the limit range is exceeded at the negative side, −α mm is treated as a fixed value.

### Tracking Control and Other Control

After coordinate processing, information about the determined tracking correction amount TC is supplied to tracking control (S4 in FIG. 2) performed by the robot control device 600. After completing a tracking control process according to the tracking correction amount TC, the robot control device 600 transmits command information (command) to the portable welding robot 100. Then, as shown in FIG. 2, the robot control device 600 proceeds to a subsequent process. The tracking correction amount TC may be a distance (mm) that cancels the aforementioned displacement amount.

With regard to a command output from the data processing device 800 related to the tracking correction amount TC to the robot control device 600, if multiple controls are executed at every cycle and every control, it is preferable that n>p, n being the number of cycles for executing a weld-line tracking control process among the total number of weaving cycles equivalent to one set, p being the number of cycles for executing a control process different from weld-line tracking. For example, one set involves performing the cycle of executing the weld-line tracking control process n times and subsequently performing the control process different from the weld-line tracking p times, and these processes are repeated until the welding is completed (S7 in FIG. 2).

An example of the control process different from the tracking control is an amplitude control process. By performing the tracking control and the amplitude control separately with the above ratio, the tracking control and the amplitude control can be executed with high accuracy. Other than the amplitude control process mentioned above, the control process different from the tracking control may be, for example, a torch-height control process. Furthermore, multiple control processes, such as the tracking control, the amplitude control, and the torch height (also referred to as a protrusion length hereinafter) control, may be combined. In this case, the number of executions n of the tracking control process may be greater than the total number of executions p obtained by adding together the number of executions of the amplitude control process and the number of executions of the protrusion-length control process.

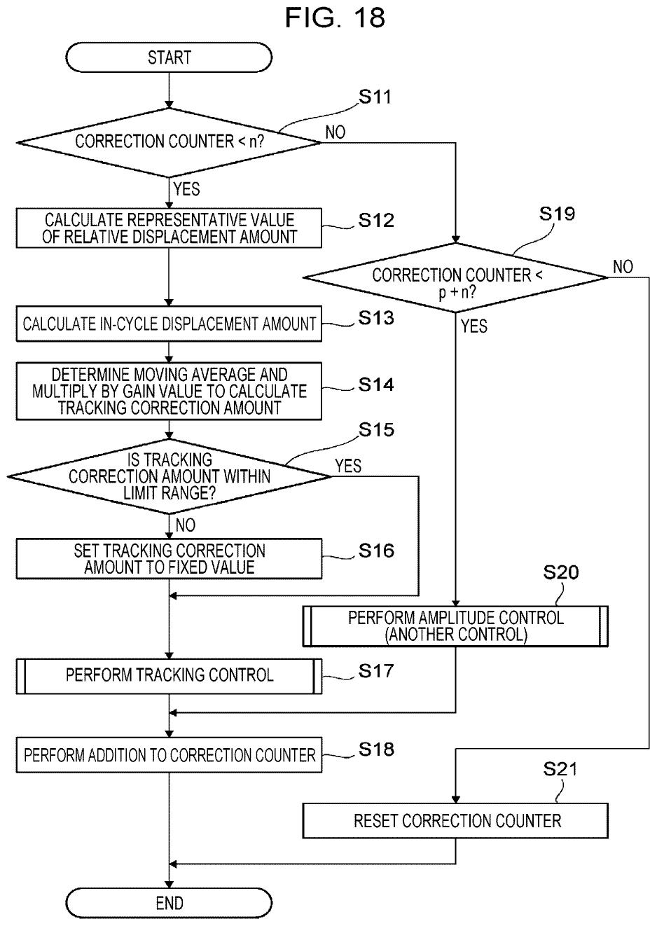

The following description with reference to flowcharts in FIGS. 2 and 18 relates to a specific procedure of the tracking-amplitude processing for causing the robot control device 600 to calculate the tracking correction amount TC based on each of the in-cycle displacement amounts (n_PosUD), (n+1_PosUD), and so on input as one of commands.

The robot control device 600 initializes each processing step at the start of welding. An example in the tracking-amplitude processing (S4 in FIG. 2) is initialization of a correction counter to be described later. Then, as shown in FIG. 2, command reception (S1) involves receiving a command for performing various processes, such as receiving a relative displacement amount from the data processing device 800. In this embodiment, after the gap processing (S2) and the welding-torch-movement processing (S3) are performed based on the received command, the tracking-amplitude processing and so on (S4, S5) are performed. When data about the relative displacement amount is input in the tracking-amplitude processing (S4), the robot control device 600 confirms that the correction counter is smaller than the number of executions n of the weld-line tracking control process (S11) and calculates the aforementioned representative value of the relative displacement amount (S12), as indicated in the flowchart in FIG. 18. Then, the in-cycle displacement amount is calculated (S13), and a moving average of the in-cycle displacement amount is further determined, where necessary, and is multiplied by the gain value, whereby the tracking correction amount TC is calculated (S14).

It is determined whether the calculated tracking correction amount TC is within the limit range (S15). If outside the limit range, the tracking correction amount is set to a predetermined fixed value (S16). If within the limit range, the calculated tracking correction amount TC is set as-is. Based on the set tracking correction amount, tracking control is executed (S17). After the execution, 1 is added to the count value of the correction counter (S18), and the process transitions to the next processing. Specifically, in this embodiment, the process proceeds to the speed processing (S5) shown in FIG. 2.

As described above, with respect to the relative displacement amount input in real time in step S1 in FIG. 2, the process from step S11 to step S18 shown in FIG. 18 is repeated until the correction counter exceeds n in the tracking-amplitude processing (S4). In other words, the tracking control is executed n times. Then, after n executions, the process returns to the routine in FIG. 2 and transitions to the next processing (S5).

When step S4 is to be performed again in the routine in FIG. 2, if the correction counter exceeds n in step S11 in FIG. 18, the process transitions to step S19. If the correction counter is smaller than the total sum of the number of executions p of the control process different from the weld-line tracking and the number of executions n of the above-described weld-line tracking control, amplitude control is executed (S20). After the execution of the amplitude control, the count value of the correction counter is increased by 1 (S18), and the process transitions to the next processing. Accordingly, the amplitude control is repeated until the correction counter exceeds the numerical value of p+n. If the correction counter exceeds the numerical value of p+n in step S19, the correction counter is reset (S21), and the process from step S11 to step S18 is repeated until the correction counter exceeds n again in a subsequent routine. Although the amplitude control as control other than the tracking control is applied in the process according to this embodiment shown in FIG. 18, another control may be performed, as mentioned above.

According to the above procedure, the weld-line tracking control and another control can be executed alternately in a well-balanced manner while the weaving operation is being performed, so that a welding process can be executed with higher accuracy.

### Welding Control Method

A welding operation of the welding system 50 during actual welding according to this embodiment will be described below. When arc welding is to be performed, the operator activates the robot control device 600, the welding power source 400, and the data processing device 800. The robot control device 600 gives a command about the welding condition to the welding power source 400 and controls the movement of the portable welding robot 100, whereby the portable welding robot 100 executes welding. The data processing device 800 receives a welding image captured by the imaging device 700 and sequentially outputs arc-welding-related feature points. In this embodiment, the feature points are the wire tip position, the arc center, the positions of the upper and lower leading ends of the molten pool, and the positions of the upper and lower ends of the molten pool.

When the arc welding is to be started, the operator operates the teaching pendant (not shown) connected to the robot control device 600, so as to input an applied teaching program and various set values to the robot control device 600. The teaching program in this case is defined as a taught program to which, for example, the movement of the portable welding robot 100 and welding start and end commands are preliminarily taught. A process to be performed after starting the program will be described below with reference to the flow of (A) to (G).

(A) The robot control device 600 receives designation of the teaching program and the various set values.

(B) After starting the teaching program, the robot control device 600 moves the portable welding robot 100 to a predetermined welding start position and gives a welding start (arc on) command to the welding power source 400. Prior to the start of the welding program, sensing, such as touch sensing or laser sensing, may be performed to correct the set values of the teaching program.

(C) The welding power source 400 receives the welding start command from the robot control device 600.

(D) The welding power source 400 supplies electric power by controlling a built-in power supply circuit (not shown), thereby causing welding to start. Accordingly, voltage is applied between the welding wire 211 (see FIG. 1) and the workpiece Wo (see FIG. 1), so that an arc is generated at the welding start position.

(E) The robot control device 600 transmits a control signal to the welding power source 400 or the portable welding robot 100 and executes welding control. The welding control includes, for example, welding condition control, control of welding torch movement including a weaving operation, and weld-line tracking control.

(F) The robot control device 600 receives a welding-control-related correction signal from the data processing device 800 until a welding stop signal is detected. The received correction signal is a signal related to a correction amount (i.e., a tracking correction amount in the case of tracking control) for various processes. The correction amount is calculated on the basis of each piece of time-series data based on the feature points that are output from the data processing device 800 by using the learned model 815B. With regard to the welding stop signal, for example, a welding stop command may be received from the operator, and it may be determined to stop the welding when the welding end position is detected in accordance with the teaching program or when a welding abnormality is detected.

In the welding condition control, the data processing device 800 calculates a correction amount for controlling at least one of the welding speed, the welding current, and the arc voltage based on the feature points obtained from the welding image, and transmits the correction-amount-related correction signal as a command to the robot control device 600. The robot control device 600 transmits a command signal according to the correction signal to the portable welding robot 100 or the welding power source 400, so that the portable welding robot 100 or the welding power source 400 executes welding. From the standpoint of the ease of control, it is preferable that welding speed control be included for obtaining stable welding. In this embodiment, welding speed control alone is performed, and, for example, the correction amount for the welding speed may be determined based on the X coordinate position of the wire tip obtained from the welding image and the difference between the upper and lower end positions of the molten pool.

In the control of the weaving operation, the data processing device 800 calculates a correction amount for controlling a condition related to a weaving condition based on the feature points obtained from the welding image, and transmits a correction-amount-related correction signal to the robot control device 600. The robot control device 600 transmits a command signal according to the correction amount to the portable welding robot 100 or the welding power source 400, whereby the portable welding robot 100 or the welding power source 400 executes welding.

In the weld-line tracking control, the data processing device 800 calculates the tracking correction amount TC in the above-described manner based on the feature points obtained from the welding image, and transmits a command value after coordinate processing as a correction signal to the robot control device 600.

The robot control device 600 transmits a command signal according to the correction signal to the portable welding robot 100, whereby the portable welding robot 100 executes welding.

(G) When a welding stop signal is detected, the robot control device 600 gives a welding stop command to the welding power source 400. The welding is stopped by stopping the supply of welding power. The robot control device 600 also commands the data processing device 800 to stop generating a correction signal. Accordingly, the welding operation of the welding system 50 ends.

Accordingly, the present invention is not limited to the above embodiment, and combining of components of the embodiment, as well as modifications and applications made by a skilled person based on the description and the known art, are also expected in the present invention and are included in the scope for which protection is sought.

Accordingly, the following items are disclosed in this description.

(1) A weaving control method for causing a welding torch to perform weaving based on command information, the weaving control method comprising:
a step for acquiring first weaving information from the command information, the first weaving information including information about a torch position during the weaving;
a step for acquiring second weaving information from image information at every predetermined sampling period, the image information being obtained by capturing an image of an area surrounding a tip of the welding torch during welding, the second weaving information including information about a welding center position and the torch position during the weaving in a weaving width direction orthogonal a weld line;
a step for setting a first stoppage period and a second stoppage period when the welding torch moves toward one side and an other side with respect to a center in the weaving width direction, the first stoppage period including a timing for stopping at a weaving end at the one side, the second stoppage period including a timing for stopping at a weaving end at the other side;
a step for calculating a representative value of a relative displacement amount between the welding center position and the torch position in each of the first stoppage period and the second stoppage period at every weaving cycle based on the second weaving information; and
a step for calculating a correction amount for weld-line tracking in accordance with an in-cycle displacement amount at every weaving cycle, the in-cycle displacement amount being determined based on the representative value of the relative displacement amount in the first stoppage period and the representative value of the relative displacement amount in the second stoppage period.

According to this weaving control method, the stop timing at each weaving end is ascertained in accordance with the first weaving information based on the command information, and the weld-line tracking correction amount is calculated by using the information about the welding center position and the torch position obtained from the image information at the stop timing. Therefore, even when the sampling rate of the image information is high, weld-line tracking control can be performed with high accuracy.

(2) The weaving control method according to (1),
wherein the image information includes image data having a two-dimensional coordinate axis, and at least the welding center position and the torch position are determined from the image data.
According to this weaving control method, the welding center position and the torch position can be determined with high accuracy from two-dimensional image data.

(3) The weaving control method according to (2),
wherein the image information includes an image of a molten pool and an image of a welding wire protruding from a torch tip,
wherein the welding center position is calculated based on a position of the molten pool obtained from the image information during the welding,
wherein the torch position at every sampling period is calculated based on a wire tip position of the welding wire protruding from the torch tip, the wire tip position being obtained from the image information about the image captured during the welding, and
wherein distinction of a weaving position at the one side or a weaving position at the other side is performed based on whether a difference value between the welding center position and the torch position is a positive value or a negative value.

This weaving control method enables easy distinction of whether the torch position is the weaving position at the one side or the weaving position at the other side depending on whether the difference value between the welding center position and the torch position is a positive value or a negative value.

(4) The weaving control method according to (3),
wherein the position of the molten pool at least includes molten-pool leading-end positions at opposite ends of the molten pool in the weaving width direction and a molten-pool center position between the molten-pool leading-end positions at the opposite ends, the molten-pool center position being calculated from the molten-pool leading-end positions at the opposite ends, and
wherein the welding center position is set to the molten-pool center position.

According to this weaving control method, the welding center position can be set more accurately in accordance with the molten-pool leading-end positions and the molten-pool center position.

(5) The weaving control method according to any one of (1) to (4),
wherein the in-cycle displacement amount is calculated by multiplying the representative value of the relative displacement amount at the one side and the representative value of the relative displacement amount at the other side by a correction coefficient.

According to this weaving control method, the multiplication by the correction coefficient can allow an actual change in the relative displacement amount to be set to an appropriate magnitude level in calculation, so that responsiveness of control can be properly adjusted.

(6) The weaving control method according to any one of (1) to (5),
wherein the correction amount for the weld-line tracking is calculated by using a moving-averaged value of in-cycle displacement amounts in cycles, the in-cycle displacement amounts being determined in a plurality of weaving cycles.

According to this weaving control method, an effect due to an occurrence of an instantaneous displacement can be suppressed, thereby achieving improved stability in control.

(7) The weaving control method according to any one of (1) to (6),
wherein a number of cycles for executing a control process for the weld-line tracking is defined as n, a number of cycles for executing a control process different from the weld-line tracking is defined as p, and the control process for the weld-line tracking and the control process different from the weld-line tracking are repeated as one set, and
wherein n>p.

According to this weaving control method, the weld-line tracking control process and the other control process can be executed efficiently.

(8) The weaving control method according to any one of (1) to (7),
wherein at least one of operations is executed when the correction amount exceeds a predetermined limit range, the operations including:
setting the correction amount to a fixed value within the predetermined limit range;
not performing weld-line tracking control in accordance with the correction amount exceeding the limit range;
transmitting an abnormality signal; and
stopping the welding.

This weaving control method enables stable control without an excessive response even when the correction amount exceeds the limit range.

(9) The weaving control method according to any one of (1) to (8),
wherein a delay time between the first weaving information and the second weaving information is calculated, and
wherein the first weaving information and the second weaving information are synchronized based on the calculated delay time.

According to this weaving control method, the first weaving information and the second weaving information can be synchronized without delay.

(10) The weaving control method according to any one of (1) to (9),
wherein a learned model is prepared using the image information as input data, the learned model being generated to output feature information related to a welding phenomenon, and
wherein at least one of the welding center position and the torch position is calculated based on the feature information output from the learned model by inputting the image information to the

According to this weaving control method, the feature information can be acquired by using the learned model.

(11) The weaving control method according to (10),
wherein the feature information at least includes a wire tip position of a welding wire protruding from a torch tip and molten-pool leading-end positions at opposite ends of a molten pool in the weaving width direction.

According to this weaving control method, the position of each feature point can be readily detected from the image information.

(12) A welding control device having a function for performing weaving control on a welding torch based on command information, the welding control device comprising:
a first information acquirer that acquires first weaving information from the command information, the first weaving information including information about a torch position during weaving;
a second information acquirer that acquires second weaving information from image information at every predetermined sampling period, the image information being obtained by capturing an image of an area surrounding a tip of the welding torch during welding, the second weaving information including information about a welding center position and the torch position during the weaving in a weaving width direction orthogonal a weld line;
a stoppage-period setting unit that sets a first stoppage period and a second stoppage period when the welding torch moves toward one side and an other side with respect to a center in the weaving width direction, the first stoppage period including a timing for stopping at a weaving end at the one side, the second stoppage period including a timing for stopping at a weaving end at the other side;
a relative-displacement-amount calculator that calculates a representative value of a relative displacement amount between the welding center position and the torch position in each of the first stoppage period and the second stoppage period at every weaving cycle based on the second weaving information; and
a correction amount calculator that calculates a correction amount for weld-line tracking in accordance with an in-cycle displacement amount at every weaving cycle, the in-cycle displacement amount being determined based on the representative value of the relative displacement amount in the first stoppage period and the representative value of the relative displacement amount in the second stoppage period.

According to this welding control device, the stop timing at each weaving end is ascertained in accordance with the first weaving information based on the command information, and the weld-line tracking correction amount is calculated by using the information about the welding center position and the torch position obtained from the image information at the stop timing. Therefore, even when the sampling rate of the image information is high, weld-line tracking control can be performed with high accuracy.

(13) A welding system comprising:
the welding control device according to (12) ;
an imaging device that captures the image of the area surrounding the tip of the welding torch during the welding; and
a welding device that changes a welding condition based on the correction amount for the weld-line tracking output from the welding control device.

According to this welding system, a high-quality workpiece having undergone proper weld-line tracking control can be obtained.

(14) A program for executing a procedure of a weaving control method for causing a welding torch to perform weaving based on command information, the program causing a computer to execute:
a step for acquiring first weaving information from the command information, the first weaving information including information about a torch position during the weaving;
a step for acquiring second weaving information from image information at every predetermined sampling period, the image information being obtained by capturing an image of an area surrounding a tip of the welding torch during welding, the second weaving information including information about a welding center position and the torch position during the weaving in a weaving width direction orthogonal a weld line;
a step for setting a first stoppage period and a second stoppage period when the welding torch moves toward one side and an other side with respect to a center in the weaving width direction, the first stoppage period including a timing for stopping at a weaving end at the one side, the second stoppage period including a timing for stopping at a weaving end at the other side;
a step for calculating a representative value of a relative displacement amount between the welding center position and the torch position in each of the first stoppage period and the second stoppage period at every weaving cycle based on the second weaving information; and
a step for calculating a correction amount for weld-line tracking in accordance with an in-cycle displacement amount at every weaving cycle, the in-cycle displacement amount being determined based on the representative value of the relative displacement amount in the first stoppage period and the representative value of the relative displacement amount in the second stoppage period.

According to this program, the stop timing at each weaving end is ascertained in accordance with the first weaving information based on the command information, and the weld-line tracking correction amount is calculated by using the information about the welding center position and the torch position obtained from the image information at the stop timing. Therefore, even when the sampling rate of the image information is high, weld-line tracking control can be performed with high accuracy.

(15) A welding method comprising a control step for performing welding under a welding condition corrected in accordance with the weaving control method according to any one of (1) to (11).

According to this welding method, a high-quality workpiece having undergone proper weld-line tracking control can be obtained.

The present application is based on Japanese Patent Application (2023-008145) filed on Jan. 23, 2023, the contents of which are hereby incorporated by reference.

### REFERENCE SIGNS LIST

10 groove
50 welding system
100 portable welding robot
200 torch
211 welding wire
300 feeding device
400 welding power source
500 shielding-gas supply source
600 robot control device
700 imaging device
800 data processing device
810 main unit
811 CPU
812 GPU
813 ROM
814 RAM
815 nonvolatile storage device
815D image data
816 input-output interface
817 communication interface
818 video output interface
819 calculator
820 input unit
830 display unit
819A first information acquirer
819B second information acquirer
819C stoppage-period setting unit
819D relative-displacement-amount calculator
819E correction amount calculator
Wo workpiece
W1 upper plate
W2 lower plate

1. A weaving control method for causing a welding torch to perform weaving based on command information, the weaving control method comprising:
a step for acquiring first weaving information from the command information, the first weaving information including information about a torch position during the weaving;
a step for acquiring second weaving information from image information at every predetermined sampling period, the image information being obtained by capturing an image of an area surrounding a tip of the welding torch during welding, the second weaving information including information about a welding center position and the torch position during the weaving in a weaving width direction orthogonal a weld line;
a step for setting a first stoppage period and a second stoppage period when the welding torch moves toward one side and an other side with respect to a center in the weaving width direction, the first stoppage period including a timing for stopping at a weaving end at the one side, the second stoppage period including a timing for stopping at a weaving end at the other side;
a step for calculating a representative value of a relative displacement amount between the welding center position and the torch position in each of the first stoppage period and the second stoppage period at every weaving cycle based on the second weaving information; and
a step for calculating a correction amount for weld-line tracking in accordance with an in-cycle displacement amount at every weaving cycle, the in-cycle displacement amount being determined based on the representative value of the relative displacement amount in the first stoppage period and the representative value of the relative displacement amount in the second stoppage period.

2. The weaving control method according to claim 1,
wherein the image information includes image data having a two-dimensional coordinate axis, and at least the welding center position and the torch position are determined from the image data.

3. The weaving control method according to claim 2,
wherein the image information includes an image of a molten pool and an image of a welding wire protruding from a torch tip,
wherein the welding center position is calculated based on a position of the molten pool obtained from the image information during the welding,
wherein the torch position at every sampling period is calculated based on a wire tip position of the welding wire protruding from the torch tip, the wire tip position being obtained from the image information about the image captured during the welding, and
wherein distinction of a weaving position at the one side or a weaving position at the other side is performed based on whether a difference value between the welding center position and the torch position is a positive value or a negative value.

4. The weaving control method according to claim 3,
wherein the position of the molten pool at least includes molten-pool leading-end positions at opposite ends of the molten pool in the weaving width direction and a molten-pool center position between the molten-pool leading-end positions at the opposite ends, the molten-pool center position being calculated from the molten-pool leading-end positions at the opposite ends, and
wherein the welding center position is set to the molten-pool center position.

5. The weaving control method according to claim 1,
wherein the in-cycle displacement amount is calculated by multiplying the representative value of the relative displacement amount at the one side and the representative value of the relative displacement amount at the other side by a correction coefficient.

6. The weaving control method according to claim 1,
wherein the correction amount for the weld-line tracking is calculated by using a moving-averaged value of in-cycle displacement amounts in cycles, the in-cycle displacement amounts being determined in a plurality of weaving cycles.

7. The weaving control method according to claim 1,
wherein a number of cycles for executing a control process for the weld-line tracking is defined as n, a number of cycles for executing a control process different from the weld-line tracking is defined as p, and the control process for the weld-line tracking and the control process different from the weld-line tracking are repeated as one set, and
wherein n>p.

8. The weaving control method according to claim 1,
wherein at least one of operations is executed when the correction amount exceeds a predetermined limit range, the operations including:
setting the correction amount to a fixed value within the predetermined limit range;
not performing weld-line tracking control in accordance with the correction amount exceeding the limit range;
transmitting an abnormality signal; and
stopping the welding.

9. The weaving control method according to claim 1,
wherein a delay time between the first weaving information and the second weaving information is calculated, and
wherein the first weaving information and the second weaving information are synchronized based on the calculated delay time.

10. The weaving control method according to claim 1,
wherein a learned model is prepared using the image information as input data, the learned model being generated to output feature information related to a welding phenomenon, and
wherein at least one of the welding center position and the torch position is calculated based on the feature information output from the learned model by inputting the image information to the learned model.

11. The weaving control method according to claim 10,
wherein the feature information at least includes a wire tip position of a welding wire protruding from a torch tip and molten-pool leading-end positions at opposite ends of a molten pool in the weaving width direction.

12. A welding control device having a function for performing weaving control on a welding torch based on command information, the welding control device comprising:
a first information acquirer that acquires first weaving information from the command information, the first weaving information including information about a torch position during weaving;
a second information acquirer that acquires second weaving information from image information at every predetermined sampling period, the image information being obtained by capturing an image of an area surrounding a tip of the welding torch during welding, the second weaving information including information about a welding center position and the torch position during the weaving in a weaving width direction orthogonal a weld line;
a stoppage-period setting unit that sets a first stoppage period and a second stoppage period when the welding torch moves toward one side and an other side with respect to a center in the weaving width direction, the first stoppage period including a timing for stopping at a weaving end at the one side, the second stoppage period including a timing for stopping at a weaving end at the other side;
a relative-displacement-amount calculator that calculates a representative value of a relative displacement amount between the welding center position and the torch position in each of the first stoppage period and the second stoppage period at every weaving cycle based on the second weaving information; and
a correction amount calculator that calculates a correction amount for weld-line tracking in accordance with an in-cycle displacement amount at every weaving cycle, the in-cycle displacement amount being determined based on the representative value of the relative displacement amount in the first stoppage period and the representative value of the relative displacement amount in the second stoppage period.

13. A welding system comprising:
the welding control device according to claim 12;
an imaging device that captures the image of the area surrounding the tip of the welding torch during the welding; and
a welding device that changes a welding condition based on the correction amount for the weld-line tracking output from the welding control device.

14. A program for executing a procedure of a weaving control method for causing a welding torch to perform weaving based on command information, the program causing a computer to execute:
a step for acquiring first weaving information from the command information, the first weaving information including information about a torch position during the weaving;
a step for acquiring second weaving information from image information at every predetermined sampling period, the image information being obtained by capturing an image of an area surrounding a tip of the welding torch during welding, the second weaving information including information about a welding center position and the torch position during the weaving in a weaving width direction orthogonal a weld line;
a step for setting a first stoppage period and a second stoppage period when the welding torch moves toward one side and an other side with respect to a center in the weaving width direction, the first stoppage period including a timing for stopping at a weaving end at the one side, the second stoppage period including a timing for stopping at a weaving end at the other side;
a step for calculating a representative value of a relative displacement amount between the welding center position and the torch position in each of the first stoppage period and the second stoppage period at every weaving cycle based on the second weaving information; and
a step for calculating a correction amount for weld-line tracking in accordance with an in-cycle displacement amount at every weaving cycle, the in-cycle displacement amount being determined based on the representative value of the relative displacement amount in the first stoppage period and the representative value of the relative displacement amount in the second stoppage period.

15. A welding method comprising a control step for performing welding under a welding condition corrected in accordance with the weaving control method according to claim 1.
